(19) United States
(12) Patent Application Publication
(10) Pub. No.: US 2025/0080292 A1
(43) Pub. Date: Mar. 6, 2025

(54) TRANSMISSION RECEPTION POINT MODE CONFIGURATION

(71) Applicant: QUALCOMM Incorporated, San Diego, CA (US)

(72) Inventors: Fang YUAN, Beijing (CN); Wooseok NAM, San Diego, CA (US); Tao LUO, San Diego, CA (US)

(21) Appl. No.: 18/293,176

(22) PCT Filed: Oct. 21, 2021
(86) PCT No.: PCT/CN2021/125253

§ 371 Date: Jan. 29, 2024

(51) Int. Cl. H04L 5/00; H04W 72/232

(52) U.S. Cl. CPC H04L 5/0035; H04W 72/232

(57) ABSTRACT

Various aspects of the present disclosure generally relate to wireless communication. In some aspects, a user equipment (UE) may receive an indication of a number of bits to be used in a downlink control information (DCI) message, the bits configured to indicate a transmission reception point (TRP) mode configuration for one or more subsequent communications. The UE may receive the DCI message having the number of bits to indicate the TRP mode configuration for the subsequent communications. Numerous other aspects are described.

### FIELD OF THE DISCLOSURE

Aspects of the present disclosure generally relate to wireless communication and to techniques and apparatuses for transmission reception point mode configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a number of bits to be used in a downlink control information (DCI) message, the bits configured to indicate a transmission reception point (TRP) mode configuration for one or more subsequent communications. The method may include receiving the DCI message having the number of bits to indicate the TRP mode configuration for the subsequent communications.

Some aspects described herein relate to a method of wireless communication performed by a base station. The method may include transmitting an indication of a number of bits to be used in a DCI message, the bits configured to indicate a TRP mode configuration for one or more subsequent communications. The method may include transmitting the DCI message having the number of bits to indicate the TRP mode configuration for the subsequent communications.

Some aspects described herein relate to a UE. The user equipment may include a memory and one or more processors coupled to the memory. The one or more processors may be configured to receive an indication of a number of bits to be used in a DCI message, the bits configured to indicate a TRP mode configuration for one or more subsequent communications. The one or more processors may be configured to receive the DCI message having the number of bits to indicate the TRP mode configuration for the subsequent communications.

Some aspects described herein relate to a base station. The base station may include a memory and one or more processors coupled to the memory. The one or more processors may be configured to transmit an indication of a number of bits to be used in a DCI message, the bits configured to indicate a TRP mode configuration for one or more subsequent communications. The one or more processors may be configured to transmit the DCI message having the number of bits to indicate the TRP mode configuration for the subsequent communications.

Some aspects described herein relate to a non-transitory computer-readable medium that stores a set of instructions by a UE. The set of instructions, when executed by one or more processors of the UE, may cause the UE to receive an indication of a number of bits to be used in a DCI message, the bits configured to indicate a TRP mode configuration for one or more subsequent communications. The set of instructions, when executed by one or more processors of the UE, may cause the UE to receive the DCI message having the number of bits to indicate the TRP mode configuration for the subsequent communications.

Some aspects described herein relate to a non-transitory computer-readable medium that stores a set of instructions by a base station. The set of instructions, when executed by one or more processors of the base station, may cause the base station to transmit an indication of a number of bits to be used in a DCI message, the bits configured to indicate a TRP mode configuration for one or more subsequent communications. The set of instructions, when executed by one or more processors of the base station, may cause the base station to transmit the DCI message having the number of bits to indicate the TRP mode configuration for the subsequent communications.

Some aspects described herein relate to an apparatus. The apparatus may include means for receiving an indication of a number of bits to be used in a DCI message, the bits configured to indicate a TRP mode configuration for one or more subsequent communications. The apparatus may include means for receiving the DCI message having the number of bits to indicate the TRP mode configuration for the subsequent communications.

Some aspects described herein relate to an apparatus. The apparatus may include means for transmitting an indication of a number of bits to be used in a DCI message, the bits configured to indicate a TRP mode configuration for one or more subsequent communications. The apparatus may include means for transmitting the DCI message having the number of bits to indicate the TRP mode configuration for the subsequent communications.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed radio access network (RAN), in accordance with the present disclosure.

FIG. 4 is a diagram illustrating an example of multi-transmission reception point (TRP) communication, in accordance with the present disclosure.

FIG. 5 is a diagram illustrating an example associated with TRP mode configuration, in accordance with the present disclosure.

FIGS. 6 and 7 are diagrams illustrating example processes associated with transmission reception point mode configuration, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

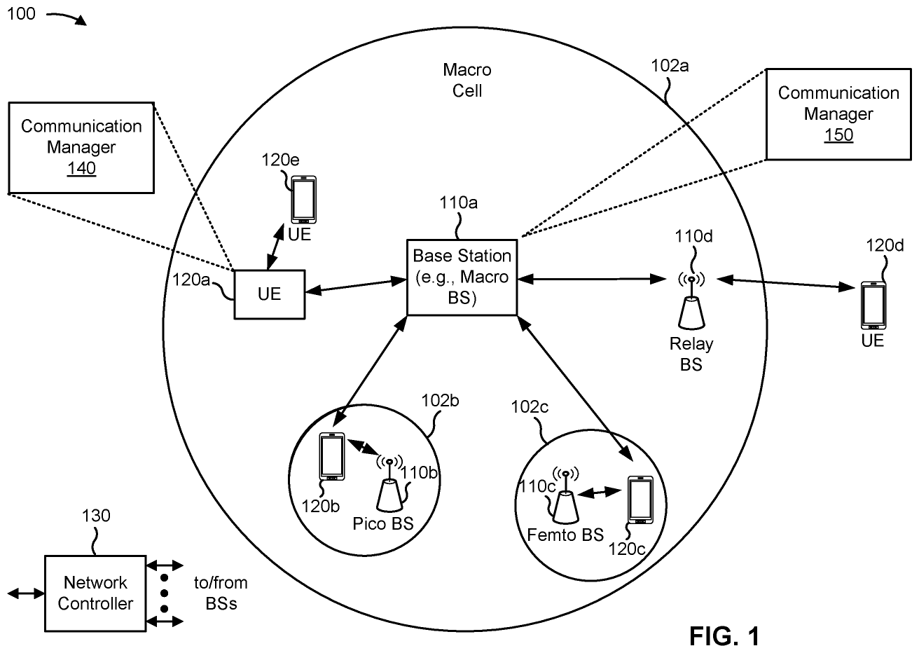

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a number of bits to be used in a DCI message, the bits configured to indicate a TRP mode configuration for one or more subsequent communications; and receive the DCI message having the number of bits to indicate the TRP mode configuration for the subsequent communications. Additionally, or alternatively, the communication manager 140 may perform one or more other operations described herein.

In some aspects, the base station 110 may include a communication manager 150. As described in more detail elsewhere herein, the communication manager 150 may transmit an indication of a number of bits to be used in a DCI message, the bits configured to indicate a TRP mode configuration for one or more subsequent communications; and transmit the DCI message having the number of bits to indicate the TRP mode configuration for the subsequent communications. Additionally, or alternatively, the communication manager 150 may perform one or more other operations described herein.

As indicated above, FIG. 1 is provided as an example. Other examples may differ from what is described with regard to FIG. 1.

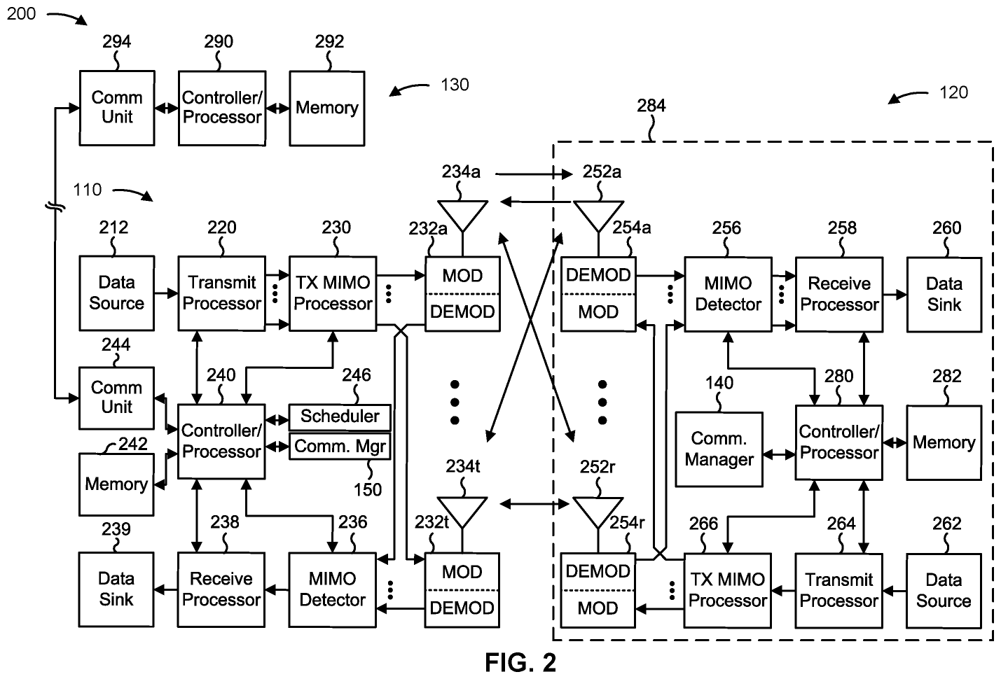

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

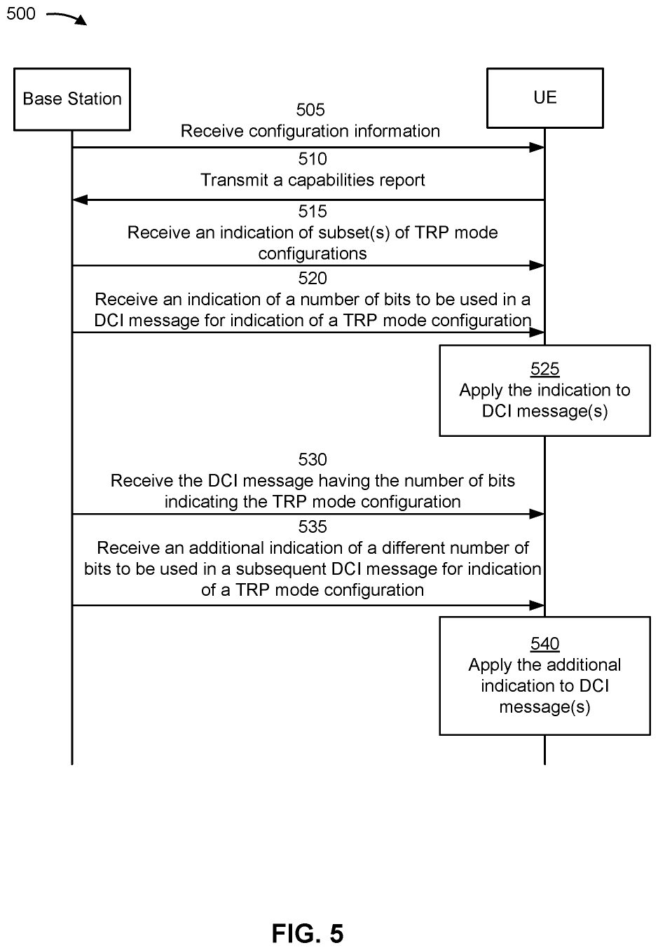

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

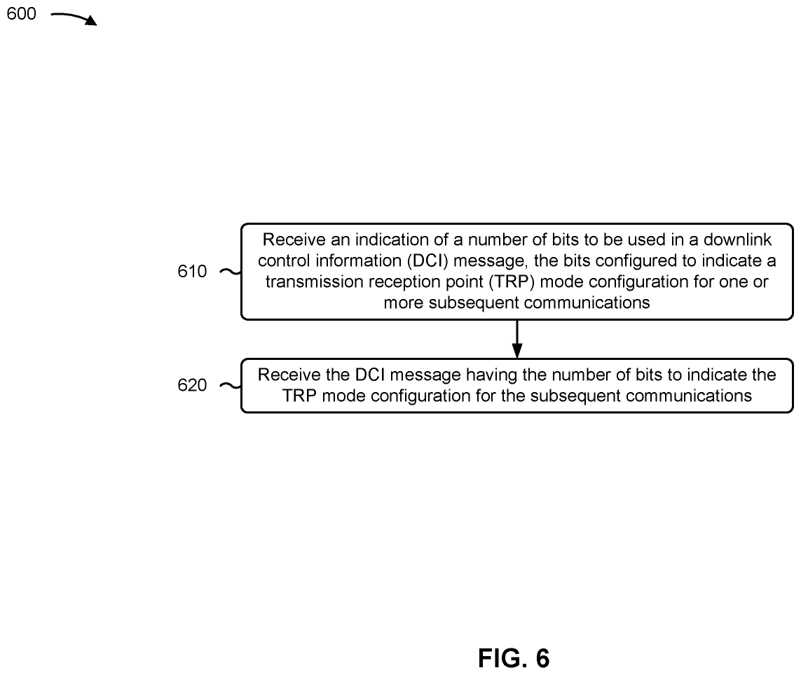

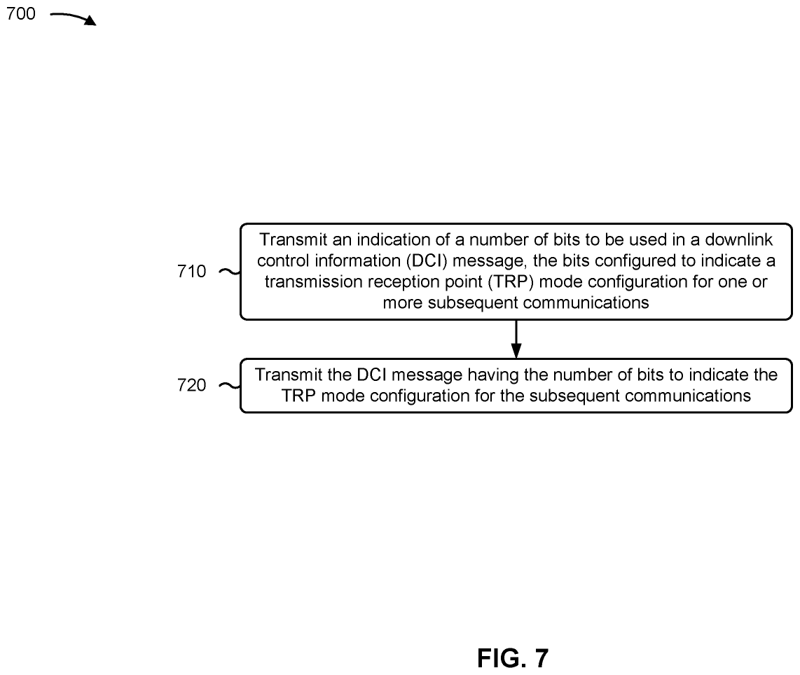

The controller/processor 240 of the base station 110, the controller/processor 280 of the UE 120, and/or any other component(s) of FIG. 2 may perform one or more techniques associated with transmission reception point mode configuration, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE includes means for receiving an indication of a number of bits to be used in a DCI message, the bits configured to indicate a TRP mode configuration for one or more subsequent communications; and/or means for receiving the DCI message having the number of bits to indicate the TRP mode configuration for the subsequent communications. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting an indication of a number of bits to be used in a DCI message, the bits configured to indicate a TRP mode configuration for one or more subsequent communications; and/or means for transmitting the DCI message having the number of bits to indicate the TRP mode configuration for the subsequent communications. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

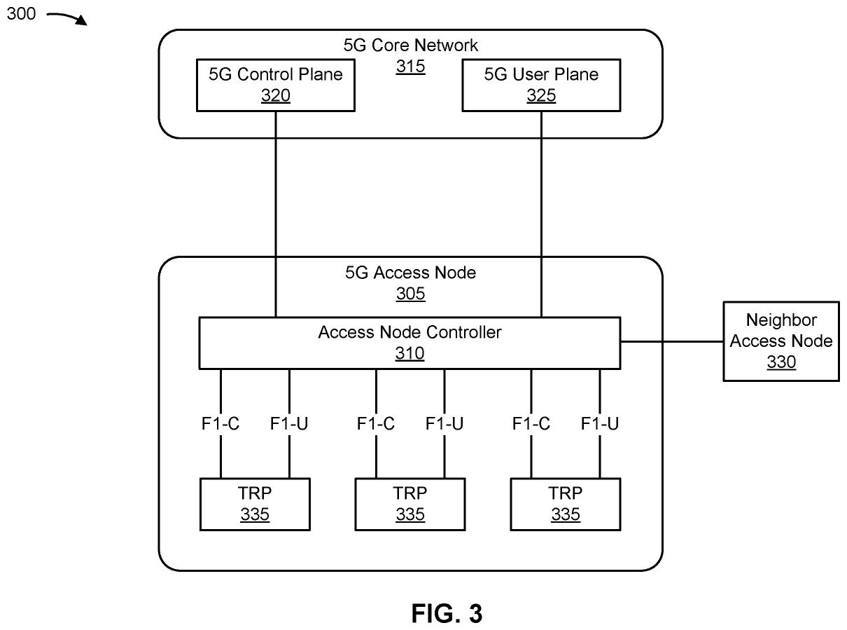

FIG. 3 illustrates an example logical architecture of a distributed RAN 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

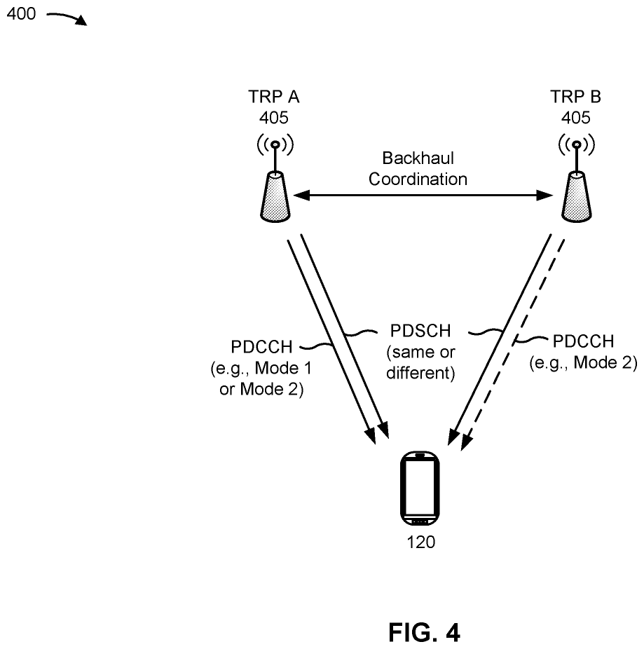

FIG. 4 is a diagram illustrating an example 400 of multi-TRP communication (sometimes referred to as multi-panel communication), in accordance with the present disclosure. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 4 is provided as an example. Other examples may differ from what is described with respect to FIG. 4.

In some networks, a UE may be configured to switch between single-TRP and multi-TRP configurations. For example, the UE may be configured to dynamically switch between configurations including one or more single-TRP configurations and/or one or more multi-TRP configurations. The one or more multi-TRP configurations may include configurations for codebook based (CB) multi-TRP data channel repetitions and/or non-CB multi-TRP data channel repetitions (e.g., a multi-TRP physical uplink shared channel (PUSCH) repetition).

A base station may indicate, via DCI, that the UE is to use a selected configuration of the one or more single-TRP configurations and/or the one or more multi-TRP configurations. A number of bits used to indicate that the UE is to use the selected configuration may be based at least in part on a configuration (e.g., in a communication protocol) and/or a number of the one or more single-TRP configurations and/or the one or more multi-TRP configurations (e.g., with codepoints for each of the one or more single-TRP configurations and/or the one or more multi-TRP configurations).

In some examples, a first codepoint for a multi-TRP configuration may indicate to use a first TRP and a second TRP, with the first TRP being associated with a first repetition (e.g., in time) and the second TRP being associated with a second repetition, and a second codepoint for a multi-TRP configuration may indicate to use the first TRP and the second TRP, with the second TRP being associated with a first repetition (e.g., in time) and the first TRP being associated with a second repetition. The first codepoint and/or the second codepoint may indicate the first TRP and the second TRP using indications of sounding reference signal (SRS) resource indicator (SRIs) (e.g., associate with SRS resource sets), a transmit precoder matrix indicator (TPMI), and/or QCL information, among other examples. After the first repetition, remaining repetitions may follow a configured mapping pattern (e.g., cyclic or sequential patterns).

In some networks, a communication protocol may support different types of DCI formats that may be used to provide an indication of the selected configuration of the one or more single-TRP configurations and/or the one or more multi-TRP configurations. For example, the DCI0_1 and DCI0_2 may be used to provide the indication, with DCI0_2 having a configurable size that is smaller than DCI0_1. For example, DCI0_2 may have a smaller size to reduce overhead and improve reliability in, for example, ultra-reliable low latency communications. An indication using an unnecessarily large number of bits to indicate the one or more single-TRP configurations and/or the one or more multi-TRP configurations may unnecessarily consume network and communication resources and may decrease benefits of using a DCI with a configurable size to reduce overhead and improve reliability.

In some aspects described herein, a DCI may use a configurable number of bits (e.g., TRP switching bits). For example, a UE and a base station may support a configurable number of TRP switching bits in a DCI (e.g., DCI0_2), with a higher layer parameter (e.g., higher than layer 1, such as MAC layer and/or radio resources control (RRC) layer signaling, among other examples).

In some aspects, if the higher layer parameter (e.g., TRP-switch-PresentDCI-1-2) indicates a size of zero bits, a TRP mode configuration may be predetermined. For example, the UE may use a TRP mode configuration (e.g., a default TRP mode configuration) that is indicated in a communication protocol and/or in RRC signaling (e.g., an RRCConfig or RR (Reconfig_message, among other examples). In some aspects, the UE may (e.g., based at least in part a rule) use a configuration of a fallback DCI that is a configured DCI or has a relationship to a DCI to be transmitted (e.g., a most recent DCI). For example, the UE may use one or more TRPs for a DCI0_2 that follow a TRP mode which is applied to a fallback DCI, such as DCI0_0, where the TRP mode may be single TRP mode. Additionally, or alternatively, the UE may use one or more TRPs for a DCI that is based at least in part on an RRC configuration (e.g., a codepoint of a DCI0_1 may be selected by an RRC parameter, such as TRP-switch-PresentDCI-1-2 for DCI0_1).

The TRP mode configuration may indicate to use a first TRP in a single-TRP configuration, to use a second TRP in a single-TRP configuration, to use both of the first TRP and the second TRP in a multi-TRP configuration with the first TRP as a first ordered TRP, or to use both of the first TRP and the second TRP in a multi-TRP configuration with the second TRP as a first ordered TRP. These TRP mode configurations may be associated with codepoints of DCI0_1.

In some aspects, if the higher layer parameter indicates fewer bits than needed to indicate all candidate configurations, the DCI may use the fewer bits to select a TRP mode configuration from a subset of the candidate configurations. In some aspects, the subset may be based at least in part on an indication in a communication protocol (e.g., to use a single-TRP mode configuration or to use a multi-TRP mode configuration when fewer bits are indicated) and/or may be indicated in RRC signaling (e.g., the subset of TRP mode configurations (e.g., associated with codepoints of DCI0_1) may be selected by TRP-switch-PresentDCI-1-2 for DCI0_1, among other examples). For example, if the higher layer parameter indicates a size of one bit when four candidate TRP mode configurations are otherwise available, a communication protocol and/or RRC signaling may indicate that the one bit is to be used to select from only two of the four candidate TRP mode configurations.

In some aspects, if the one bit is set to 0, the DCI indicates a multi-TRP mode configuration, in an order of first TRP and second TRP (e.g., associated with a codepoint “10” in DCI0_1) and if the one bit is set to 1, the DCI indicates a multi-TRP mode configuration, in an order of second TRP and first TRP (e.g., associated with codepoint “11” in DCI0-1). Alternatively (e.g., based at least in part on a communication protocol and/or RRC signaling), if the one bit is set to 0, the DCI indicates a first TRP in a signal-TRP mode configuration (e.g., associated with a codepoint “00” in DCI0-1) and if the one bit is set to 1, the DCI indicates a multi-TRP mode configuration, in order of the first TRP and the second TRP (e.g., associated with codepoint “10” in DCI0-1).

In some aspects, if the higher layer parameter indicates a sufficient number of bits to indicate all candidate configurations, the DCI may indicate any of the candidate configurations. For example, if the higher layer parameters indicate that two bits are to be used to indicate one of four candidate configurations, each of the four candidate configurations may be associated with a different codepoint of the two bits.

Based at least in part on a DCI having a configurable number of bits to indicate a TRP mode configuration and/or using higher layer signaling and/or a communication protocol (e.g., a rule) to indicate a subset of candidate TRP mode configurations, a UE and a base station may conserve communication and network resources that may have otherwise been used to always use a maximum number of bits to indicate the TRP mode configuration.

FIG. 5 is a diagram illustrating an example 500 associated with TRP mode configuration, in accordance with the present disclosure. As shown in FIG. 5, a base station (e.g., base station 110) may communicate with a UE (e.g., UE 120). In some aspects, the base station and the UE may be part of a wireless network (e.g., wireless network 100). The UE and the base station may have established a wireless connection prior to operations shown in FIG. 5. The base station and the UE may be associated with one or more TRPs through which the base station and the UE may communicate.

As shown by reference number 505, the base station may transmit, and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (e.g., already known to the UE) for selection by the UE, or explicit configuration information for the UE to use to configure the UE, among other examples.

In some aspects, the configuration information may indicate a mapping of code points of a field in a DCI to fewer than all candidate TRP mode configurations. In some aspects, the configuration information may indicate that the UE is to receive an indication of a mapping of code points of a field in a DCI to fewer than all candidate TRP mode configurations. In some aspects, the configuration information may indicate that the UE is to receive an indication of a number of bits to be used in a DCI message for indication of a TRP mode configuration. In some aspects, the configuration information may indicate that the UE is to apply the indication of the number of bits to a number of DCI messages based at least in part on, for example, an amount of time, a number of DCI messages received, and/or an absence of an additional indication of a different number of bits to be used.

The UE may configure itself based at least in part on the configuration information. In some aspects, the UE may be configured to perform one or more operations described herein based at least in part on the configuration information.

As shown by reference number 510, the UE may transmit, and the base station may receive, a capabilities report. The capabilities report may indicate UE support for a DCI indicating a TRP mode configuration using a number of bits that is less than a number required to map unique code points to each candidate TRP mode configuration. In some aspects, the capabilities report may indicate whether the UE supports multi-TRP mode configurations.

As shown by reference number 515, the UE may receive, and the base station may transmit, an indication of one or more subsets of TRP mode configurations (e.g., candidate TRP mode configurations). In some aspects, example, the UE may receive an indication of one or more subsets of TRP mode configurations to use when different numbers of bits are to be used in a DCI message to indicate a TRP mode configuration. For example, the UE may receive an indication to use a subset of the TRP configurations when a number of bits is one and a number of TRP mode configurations is four. The subset of TRP configurations may include TRP mode configurations where a first TRP is a first ordered TRP (e.g., a single-TRP mode configuration with the first TRP and a multi-TRP mode configuration with the first TRP ordered before a second TRP), where the second TRP is the first ordered TRP, where only single-TRP mode configurations are used, or where only multi-TRP mode configurations are used, among other examples.

In some aspects, different subsets may be used based at least in part on different communication parameters. In some aspects, the subset may be selected based at least in part on a communication protocol that identifies the subset of candidate TRP mode configurations from a set of candidate TRP mode configurations. In some aspects, the subset may be selected based at least in part on an indication of the subset of candidate TRP mode configurations from the set of candidate TRP mode configurations using, for example RRC signaling and/or MAC signaling. In some aspects, different subsets may be used based at least in part on a number of bits to be used in a DCI message. For example, if the number of bits is zero, a default TRP mode configurations may be used and/or a previously indicated TRP mode configurations may be used without further indication in the DCI message. If the number of bits is one, the UE may expect to receive an indication of a selected TRP mode configuration from a subset of the candidate TRP mode configurations.

As shown by reference number 520, the UE may receive, and the base station may transmit, an indication of a number of bits to be used in a DCI message. For example, the UE may receive an indication of a number of bits to be used in a DCI message, the bits configured to indicate a TRP mode configuration for one or more subsequent communications. In some aspects, the UE may receive the indication of the number of bits via RRC signaling and/or MAC signaling, among other examples. In some aspects, the UE may transmit the indication that is less frequently received than the DCI message that carries the number of bits.

In some aspects, the DCI message may have a configurable size. For example, the DCI message (e.g., a DCI0_2) may have a field for indicating the TRP mode configurations, where the field has a configurable size.

In some aspects, the indication of the number of bits to be used in the DCI message may be based at least in part on a DCI type of the DCI message. For example the indication of the number of bits may indicate the number of bits for only one DCI type or the indication of the number of bits may indicate different numbers of bits for different DCI types, among other examples.

As shown by reference number 525, the UE may apply the indication to one or more DCI messages. In some aspects, the UE may apply the indication to DCI messages (e.g. all DCI messages or DCI messages of indicated types) received within a time window after receiving the indication of the number of bits to be used in the DCI message. In some aspects, the UE may apply the indication to DCI messages (e.g. all DCI messages or DCI messages of indicated types) until a reception of a subsequent indication of the number of bits to be used in the DCI message. In some aspects, the UE may receive an indication of the time window, for example, along with the indication of reference number 520 or in another communication, such as the configuration information of reference number 505, among other examples.

In some aspects where the indicated number of bits is zero, the UE may apply a default TRP mode configuration or a previously configured TRP mode configuration. For example, where the indicated number of bits is zero, the UE may apply a previously indicated TRP mode configuration.

As shown by reference number 530, the UE may receive, and the base station may transmit, the DCI message having the number of bits indicating the TRP mode configuration. For example, the UE may receive the DCI message after receiving the indication of the number of bits to be used in the DCI message. In some aspects, the DCI message may indicate the TRP mode configuration from all candidate TRP mode configurations (e.g., if a number of bits is sufficient to map unique codepoint so each of the candidate TRP mode configurations), from a subset of the candidate TRP mode configurations (e.g., if a number of bits is insufficient to map unique codepoint so each of the candidate TRP mode configurations), or may implicitly indicate the TRP mode configuration (e.g., if the number of bits is zero), among other examples. For example, if the number of bits is one, the DCI message may indicate the TRP mode configuration from a subset (e.g., two) of candidate TRP mode configurations.

As shown by reference number 535, the UE may receive, and the base station may transmit, an additional (e.g., subsequent) indication of a different number of bits to be used in a subsequent DCI message for indication of a TRP mode configuration. For example, the UE may receive the additional indication via RRC signaling and/or MAC signaling to update and or change the number of bits. Additionally, or alternatively, the UE may receive an indication to update and/or change one or more subsets of TRP mode configurations to use when receiving the subsequent DCI message for indication of a TRP mode configuration. For example, the UE may receive an indication to use a subset of only multi-TRP mode configurations when the indication of the subset of TRP mode configurations of reference number 515 indicated to use a subset of only single-TRP mode configurations. The base station may transmit the indication of the different number of bits and/or the indication to update and/or change the one or more subsets of TRP mode configurations based at least in part on a change of channel conditions. For example, the base station may transmit the indication of the different number of bits and/or the indication to update and/or change the one or more subsets of TRP mode configurations based at least in part on a change in mobility of the UE, a geolocation of the UE, and/or a change in speed of the UE (e.g., associated with riding a vehicle, such as a high speed train, among other examples).

As shown by reference number 540, the UE may apply the additional indication to one or more DCI messages. In some aspects, the UE may apply the indication to DCI messages (e.g., all DCI messages or DCI messages of indicated types) received within a time window after receiving the additional indication of the different number of bits to be used in the subsequent DCI message(s). In some aspects, the UE may apply the indication to DCI messages (e.g. all DCI messages or DCI messages of indicated types) until a reception of a subsequent indication of the number of bits to be used in the DCI message.

Based at least in part on a DCI having a configurable number of bits to indicate a TRP mode configuration and/or using higher layer signaling and/or a communication protocol (e.g., a rule) to indicate a subset of candidate TRP mode configurations, the UE and the base station may conserve communication and network resources that may have otherwise been used to always use a maximum number of bits to indicate the TRP mode configuration.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with TRP mode configuration.

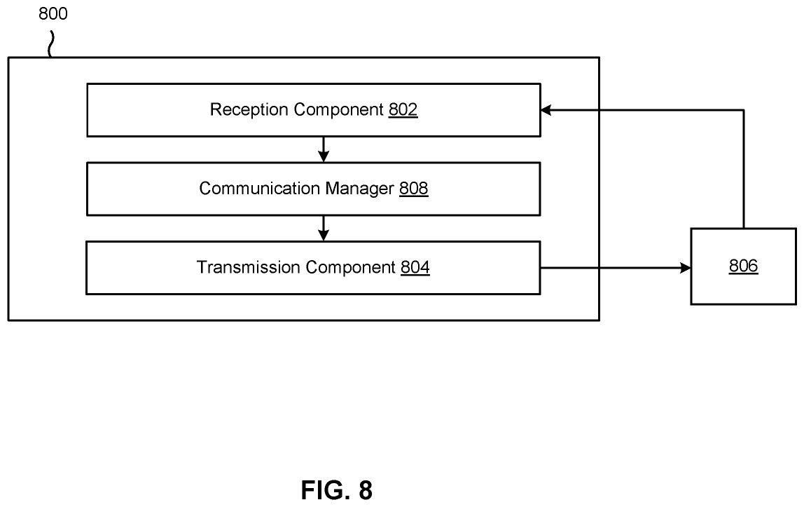

As shown in FIG. 6, in some aspects, process 600 may include receiving an indication of a number of bits to be used in a DCI message, the bits configured to indicate a TRP mode configuration for one or more subsequent communications (block 610). For example, the UE (e.g., using communication manager 140 and/or reception component 802, depicted in FIG. 8) may receive an indication of a number of bits to be used in a DCI message, the bits configured to indicate a TRP mode configuration for one or more subsequent communications, as described above.

As further shown in FIG. 6, in some aspects, process 600 may include receiving the DCI message having the number of bits to indicate the TRP mode configuration for the subsequent communications (block 620). For example, the UE (e.g., using communication manager 140 and/or reception component 802, depicted in FIG. 8) may receive the DCI message having the number of bits to indicate the TRP mode configuration for the subsequent communications, as described above.

Process 600 may include additional aspects, such as any single aspect or any combination of aspects described below and/or in connection with one or more other processes described elsewhere herein.

In a first aspect, the DCI message indicates a selection of one of a single-TRP mode associated with a first SRS resource set, a single-TRP mode associated with a second SRS resource set, a multi-TRP mode having the first SRS resource set and the second SRS resource set, with the first SRS resource set prioritized over the second SRS resource set, or a multi-TRP mode having the first SRS resource set and the second SRS resource set, with the second SRS resource set prioritized over the first SRS resource set.

In a second aspect, alone or in combination with the first aspect, the DCI message has a configurable payload size.

In a third aspect, alone or in combination with one or more of the first and second aspects, receiving the indication of the number of bits to be used in the DCI message comprises receiving the indication of the number of bits via RRC signaling.

In a fourth aspect, alone or in combination with one or more of the first through third aspects, the indication of the number of bits to be used in the DCI message is based at least in part on a DCI type of the DCI message.

In a fifth aspect, alone or in combination with one or more of the first through fourth aspects, the indication of the number of bits to be used in the DCI message applies to DCI messages received within a time window after receiving the indication of the number of bits to be used in the DCI message, or wherein the indication of the number of bits to be used in the DCI message applies to DCI messages until a reception of a subsequent indication of the number of bits to be used in the DCI message.

In a sixth aspect, alone or in combination with one or more of the first through fifth aspects, process 600 includes wherein, after the time window, the number of bits to be used in subsequent DCI messages is a previously configured number of bits.

In a seventh aspect, alone or in combination with one or more of the first through sixth aspects, the number of bits is zero and the TRP mode configuration is a default TRP mode configuration, or wherein the number of bits is zero and the TRP mode configuration is a previously configured TRP mode configuration.

In an eighth aspect, alone or in combination with one or more of the first through seventh aspects, the number of bits is one and the DCI message indicates the TRP mode configuration from a subset of candidate TRP mode configurations.

In a ninth aspect, alone or in combination with one or more of the first through eighth aspects, the subset of candidate TRP mode configurations is based at least in part on one or more of a communication protocol that identifies the subset of candidate TRP mode configurations from a set of candidate TRP mode configurations, or an indication of the subset of candidate TRP mode configurations from the set of candidate TRP mode configurations.

In a tenth aspect, alone or in combination with one or more of the first through ninth aspects, the subset of candidate TRP mode configurations comprises candidate TRP mode configurations associated with a single-TRP mode, or candidate TRP mode configurations associated with a multi-TRP mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with TRP mode configuration.

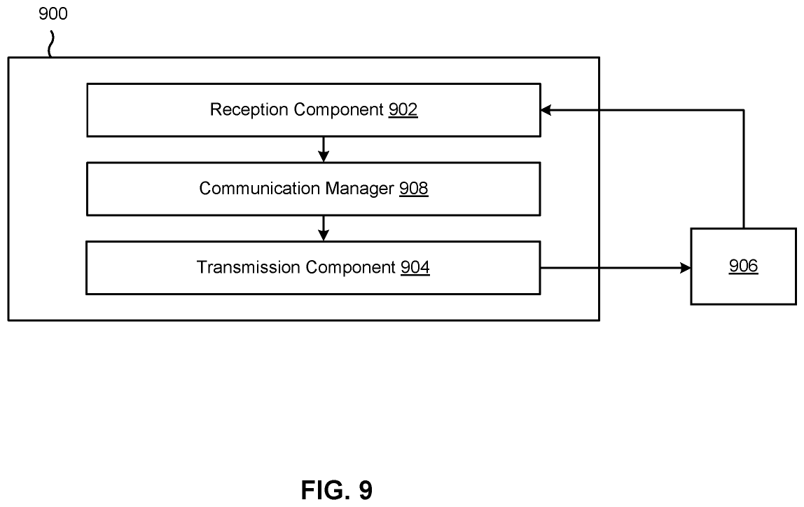

As shown in FIG. 7, in some aspects, process 700 may include transmitting an indication of a number of bits to be used in a DCI message, the bits configured to indicate a TRP mode configuration for one or more subsequent communications (block 710). For example, the base station (e.g., using communication manager 150 and/or transmission component 904, depicted in FIG. 9) may transmit an indication of a number of bits to be used in a DCI message, the bits configured to indicate a TRP mode configuration for one or more subsequent communications, as described above.

As further shown in FIG. 7, in some aspects, process 700 may include transmitting the DCI message having the number of bits to indicate the TRP mode configuration for the subsequent communications (block 720). For example, the base station (e.g., using communication manager 150 and/or transmission component 904, depicted in FIG. 9) may transmit the DCI message having the number of bits to indicate the TRP mode configuration for the subsequent communications, as described above.

Process 700 may include additional aspects, such as any single aspect or any combination of aspects described below and/or in connection with one or more other processes described elsewhere herein.

In a first aspect, the DCI message indicates a selection of one of a single-TRP mode associated with a first SRS resource set, a single-TRP mode associated with a second SRS resource set, a multi-TRP mode having the first SRS resource set and the second SRS resource set, with the first SRS resource set prioritized over the second SRS resource set, or a multi-TRP mode having the first SRS resource set and the second SRS resource set, with the second SRS resource set prioritized over the first SRS resource set.

In a second aspect, alone or in combination with the first aspect, the DCI message has a configurable payload size.

In a third aspect, alone or in combination with one or more of the first and second aspects, transmitting the indication of the number of bits to be used in the DCI message comprises transmitting the indication of the number of bits via RRC signaling.

In a fourth aspect, alone or in combination with one or more of the first through third aspects, the indication of the number of bits to be used in the DCI message is based at least in part on a DCI type of the DCI message.

In a fifth aspect, alone or in combination with one or more of the first through fourth aspects, the indication of the number of bits to be used in the DCI message applies to DCI messages received within a time window after transmitting the indication of the number of bits to be used in the DCI message, or wherein the indication of the number of bits to be used in the DCI message applies to DCI messages until a transmission of a subsequent indication of the number of bits to be used in the DCI message.

In a sixth aspect, alone or in combination with one or more of the first through fifth aspects, process 700 includes wherein, after the time window, the number of bits to be used in subsequent DCI messages is a previously configured number of bits.

In a seventh aspect, alone or in combination with one or more of the first through sixth aspects, the number of bits is zero and the TRP mode configuration is a default TRP mode configuration, or wherein the number of bits is zero and the TRP mode configuration is a previously configured TRP mode configuration.

In an eighth aspect, alone or in combination with one or more of the first through seventh aspects, the number of bits is one and the DCI message indicates the TRP mode configuration from a subset of candidate TRP mode configurations.

In a ninth aspect, alone or in combination with one or more of the first through eighth aspects, the subset of candidate TRP mode configurations is based at least in part on one or more of a communication protocol that identifies the subset of candidate TRP mode configurations from a set of candidate TRP mode configurations, or an indication of the subset of candidate TRP mode configurations from the set of candidate TRP mode configurations.

In a tenth aspect, alone or in combination with one or more of the first through ninth aspects, the subset of candidate TRP mode configurations comprises candidate TRP mode configurations associated with a single-TRP mode, or candidate TRP mode configurations associated with a multi-TRP mode.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808 (e.g., the communication manager 140).

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive an indication of a number of bits to be used in a DCI message, the bits configured to indicate a TRP mode configuration for one or more subsequent communications. The reception component 802 may receive the DCI message having the number of bits to indicate the TRP mode configuration for the subsequent communications.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908 (e.g., the communication manager 150).

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The transmission component 904 may transmit an indication of a number of bits to be used in a DCI message, the bits configured to indicate a TRP mode configuration for one or more subsequent communications. The transmission component 904 may transmit the DCI message having the number of bits to indicate the TRP mode configuration for the subsequent communications.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication of a number of bits to be used in a downlink control information (DCI) message, the bits configured to indicate a transmission reception point (TRP) mode configuration for one or more subsequent communications; and receiving the DCI message having the number of bits to indicate the TRP mode configuration for the subsequent communications.

Aspect 2: The method of Aspect 1, wherein the DCI message indicates a selection of one of: a single-TRP mode associated with a first sounding reference signal (SRS) resource set, a single-TRP mode associated with a second SRS resource set, a multi-TRP mode having the first SRS resource set and the second SRS resource set, with the first SRS resource set prioritized over the second SRS resource set, or a multi-TRP mode having the first SRS resource set and the second SRS resource set, with the second SRS resource set prioritized over the first SRS resource set.

Aspect 3: The method of any of Aspects 1-2, wherein the DCI message has a configurable payload size.

Aspect 4: The method of any of Aspects 1-3, wherein receiving the indication of the number of bits to be used in the DCI message comprises: receiving the indication of the number of bits via radio resource control (RRC) signaling.

Aspect 5: The method of Aspect 4, wherein the indication of the number of bits to be used in the DCI message is based at least in part on a DCI type of the DCI message.

Aspect 6: The method of any of Aspects 1-5, wherein the indication of the number of bits to be used in the DCI message applies to DCI messages received within a time window after receiving the indication of the number of bits to be used in the DCI message, or wherein the indication of the number of bits to be used in the DCI message applies to DCI messages until a reception of a subsequent indication of the number of bits to be used in the DCI message.

Aspect 7: The method of Aspect 6, wherein, after the time window, the number of bits to be used in subsequent DCI messages is a default number of bits, or wherein, after the time window, the number of bits to be used in subsequent DCI messages is a previously configured number of bits.

Aspect 8: The method of any of Aspects 1-7, wherein the number of bits is zero and the TRP mode configuration is a default TRP mode configuration, or wherein the number of bits is zero and the TRP mode configuration is a previously configured TRP mode configuration.

Aspect 9: The method of any of Aspects 1-8, wherein the number of bits is one and the DCI message indicates the TRP mode configuration from a subset of candidate TRP mode configurations.

Aspect 10: The method of Aspect 9, wherein the subset of candidate TRP mode configurations is based at least in part on one or more of: a communication protocol that identifies the subset of candidate TRP mode configurations from a set of candidate TRP mode configurations, or an indication of the subset of candidate TRP mode configurations from the set of candidate TRP mode configurations.

Aspect 11: The method of any of Aspects 9-10, wherein the subset of candidate TRP mode configurations comprises: candidate TRP mode configurations associated with a single-TRP mode, or candidate TRP mode configurations associated with a multi-TRP mode.

Aspect 12: A method of wireless communication performed by a base station, comprising: transmitting an indication of a number of bits to be used in a downlink control information (DCI) message, the bits configured to indicate a transmission reception point (TRP) mode configuration for one or more subsequent communications; and transmitting the DCI message having the number of bits to indicate the TRP mode configuration for the subsequent communications.

Aspect 13: The method of Aspect 12, wherein the DCI message indicates a selection of one of: a single-TRP mode associated with a first sounding reference signal (SRS) resource set, a single-TRP mode associated with a second SRS resource set, a multi-TRP mode having the first SRS resource set and the second SRS resource set, with the first SRS resource set prioritized over the second SRS resource set, or a multi-TRP mode having the first SRS resource set and the second SRS resource set, with the second SRS resource set prioritized over the first SRS resource set.

Aspect 14: The method of any of Aspects 12-13, wherein the DCI message has a configurable payload size.

Aspect 15: The method of any of Aspects 12-14, wherein transmitting the indication of the number of bits to be used in the DCI message comprises: transmitting the indication of the number of bits via radio resource control (RRC) signaling.

Aspect 16: The method of Aspect 15, wherein the indication of the number of bits to be used in the DCI message is based at least in part on a DCI type of the DCI message.

Aspect 17: The method of any of Aspects 12-16, wherein the indication of the number of bits to be used in the DCI message applies to DCI messages received within a time window after transmitting the indication of the number of bits to be used in the DCI message, or wherein the indication of the number of bits to be used in the DCI message applies to DCI messages until a transmission of a subsequent indication of the number of bits to be used in the DCI message.

Aspect 18: The method of Aspect 17, wherein, after the time window, the number of bits to be used in subsequent DCI messages is a default number of bits, or wherein, after the time window, the number of bits to be used in subsequent DCI messages is a previously configured number of bits.

Aspect 19: The method of any of Aspects 12-18, wherein the number of bits is zero and the TRP mode configuration is a default TRP mode configuration, or wherein the number of bits is zero and the TRP mode configuration is a previously configured TRP mode configuration.

Aspect 20: The method of any of Aspects 12-19, wherein the number of bits is one and the DCI message indicates the TRP mode configuration from a subset of candidate TRP mode configurations.

Aspect 21: The method of Aspect 20, wherein the subset of candidate TRP mode configurations is based at least in part on one or more of: a communication protocol that identifies the subset of candidate TRP mode configurations from a set of candidate TRP mode configurations, or an indication of the subset of candidate TRP mode configurations from the set of candidate TRP mode configurations.

Aspect 22: The method of any of Aspects 20-21, wherein the subset of candidate TRP mode configurations comprises: candidate TRP mode configurations associated with a single-TRP mode, or candidate TRP mode configurations associated with a multi-TRP mode.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a number of bits to be used in a downlink control information (DCI) message, the bits configured to indicate a transmission reception point (TRP) mode configuration for one or more subsequent communications; and
receive the DCI message having the number of bits to indicate the TRP mode configuration for the subsequent communications.

2. The UE of claim 1, wherein the DCI message indicates a selection of one of:
a single-TRP mode associated with a first sounding reference signal (SRS) resource set,
a single-TRP mode associated with a second SRS resource set,
a multi-TRP mode having the first SRS resource set and the second SRS resource set, with the first SRS resource set prioritized over the second SRS resource set, or
a multi-TRP mode having the first SRS resource set and the second SRS resource set, with the second SRS resource set prioritized over the first SRS resource set.

3. The UE of claim 1, wherein the DCI message has a configurable payload size.

4. The UE of claim 1, wherein the one or more processors, to receive the indication of the number of bits to be used in the DCI message, are configured to:
receive the indication of the number of bits via radio resource control (RRC) signaling.

5. The UE of claim 4, wherein the indication of the number of bits to be used in the DCI message is based at least in part on a DCI type of the DCI message.

6. The UE of claim 1, wherein the indication of the number of bits to be used in the DCI message applies to DCI messages received within a time window after receiving the indication of the number of bits to be used in the DCI message, or
wherein the indication of the number of bits to be used in the DCI message applies to DCI messages until a reception of a subsequent indication of the number of bits to be used in the DCI message.

7. The UE of claim 6, wherein, after the time window, the number of bits to be used in subsequent DCI messages is a default number of bits, or
wherein, after the time window, the number of bits to be used in subsequent DCI messages is a previously configured number of bits.

8. The UE of claim 1, wherein the number of bits is zero and the TRP mode configuration is a default TRP mode configuration, or
wherein the number of bits is zero and the TRP mode configuration is a previously configured TRP mode configuration.

9. The UE of claim 1, wherein the number of bits is one and the DCI message indicates the TRP mode configuration from a subset of candidate TRP mode configurations.

10. The UE of claim 9, wherein the subset of candidate TRP mode configurations is based at least in part on one or more of:
a communication protocol that identifies the subset of candidate TRP mode configurations from a set of candidate TRP mode configurations, or
an indication of the subset of candidate TRP mode configurations from the set of candidate TRP mode configurations.

11. The UE of claim 9, wherein the subset of candidate TRP mode configurations comprises:
candidate TRP mode configurations associated with a single-TRP mode, or
candidate TRP mode configurations associated with a multi-TRP mode.

12. A base station for wireless communication, comprising:
a memory; and
one or more processors, coupled to the memory, configured to:
transmit an indication of a number of bits to be used in a downlink control information (DCI) message, the bits configured to indicate a transmission reception point (TRP) mode configuration for one or more subsequent communications; and
transmit the DCI message having the number of bits to indicate the TRP mode configuration for the subsequent communications.

13. The base station of claim 12, wherein the DCI message indicates a selection of one of:
a single-TRP mode associated with a first sounding reference signal (SRS) resource set,
a single-TRP mode associated with a second SRS resource set,
a multi-TRP mode having the first SRS resource set and the second SRS resource set, with the first SRS resource set prioritized over the second SRS resource set, or
a multi-TRP mode having the first SRS resource set and the second SRS resource set, with the second SRS resource set prioritized over the first SRS resource set.

14. The base station of claim 12, wherein the DCI message has a configurable payload size.

15. The base station of claim 12, wherein the one or more processors, to transmit the indication of the number of bits to be used in the DCI message, are configured to:
transmit the indication of the number of bits via radio resource control (RRC) signaling.

16. The base station of claim 15, wherein the indication of the number of bits to be used in the DCI message is based at least in part on a DCI type of the DCI message.

17. The base station of claim 12, wherein the indication of the number of bits to be used in the DCI message applies to DCI messages received within a time window after transmitting the indication of the number of bits to be used in the DCI message, or
wherein the indication of the number of bits to be used in the DCI message applies to DCI messages until a transmission of a subsequent indication of the number of bits to be used in the DCI message.

18. The base station of claim 17, wherein, after the time window, the number of bits to be used in subsequent DCI messages is a default number of bits, or
wherein, after the time window, the number of bits to be used in subsequent DCI messages is a previously configured number of bits.

19. The base station of claim 12, wherein the number of bits is zero and the TRP mode configuration is a default TRP mode configuration, or
wherein the number of bits is zero and the TRP mode configuration is a previously configured TRP mode configuration.

20. The base station of claim 12, wherein the number of bits is one and the DCI message indicates the TRP mode configuration from a subset of candidate TRP mode configurations.

21. The base station of claim 20, wherein the subset of candidate TRP mode configurations is based at least in part on one or more of:
a communication protocol that identifies the subset of candidate TRP mode configurations from a set of candidate TRP mode configurations, or
an indication of the subset of candidate TRP mode configurations from the set of candidate TRP mode configurations.

22. The base station of claim 20, wherein the subset of candidate TRP mode configurations comprises:
candidate TRP mode configurations associated with a single-TRP mode, or
candidate TRP mode configurations associated with a multi-TRP mode.

23. A method of wireless communication performed by a user equipment (UE), comprising:
receiving an indication of a number of bits to be used in a downlink control information (DCI) message, the bits configured to indicate a transmission reception point (TRP) mode configuration for one or more subsequent communications; and
receiving the DCI message having the number of bits to indicate the TRP mode configuration for the subsequent communications.

24. The method of claim 23, wherein the DCI message has a configurable payload size.

25. The method of claim 23, wherein the number of bits is zero and the TRP mode configuration is a default TRP mode configuration, or
wherein the number of bits is zero and the TRP mode configuration is a previously configured TRP mode configuration.

26. The method of claim 23, wherein the number of bits is one and the DCI message indicates the TRP mode configuration from a subset of candidate TRP mode configurations.

27. A method of wireless communication performed by a base station, comprising:
transmitting an indication of a number of bits to be used in a downlink control information (DCI) message, the bits configured to indicate a transmission reception point (TRP) mode configuration for one or more subsequent communications; and
transmitting the DCI message having the number of bits to indicate the TRP mode configuration for the subsequent communications.

28. The method of claim 27, wherein the DCI message has a configurable payload size.

29. The method of claim 27, wherein the number of bits is zero and the TRP mode configuration is a default TRP mode configuration, or
wherein the number of bits is zero and the TRP mode configuration is a previously configured TRP mode configuration.

30. The method of claim 27, wherein the number of bits is one and the DCI message indicates the TRP mode configuration from a subset of candidate TRP mode configurations.
